(19) United States
(12) Patent Application Publication
(10) Pub. No.: US 2024/0067866 A1
(43) Pub. Date: Feb. 29, 2024

(54) ETHER AND CARBON DIOXIDE MIXTURES TO ENHANCE HYDROCARBON RECOVERY FROM AN UNDERGROUND FORMATION

(71) Applicant: Saudi Arabian Oil Company, Dhahran (SA)

(72) Inventors: Anuj Gupta, Houston, TX (US); Ravimadhav N. Vaidya, Houston, TX (US)

(21) Appl. No.: 17/893,813

(22) Filed: Aug. 23, 2022

(51) Int. Cl. C09K 8/594; C09K 8/588

(52) U.S. Cl. CPC C09K 8/594; C09K 8/588

(57) ABSTRACT

The disclosure relates to methods to increase production of a hydrocarbon from an underground formation by injecting a mixture containing an ether and carbon dioxide. The composition of the mixture, a pressure for injecting the mixture, a duration of an injection time, a duration of a time delay between injection of the mixture and producing the hydrocarbon, a pressure for producing the hydrocarbon, a duration of a production time and/or a number of cycles of injection and production can be selected (e.g., optimized) using simulations to enhance (e.g., maximize) recovery of the hydrocarbon and/or sequestration of carbon dioxide in the underground formation.

### FIELD

The disclosure relates to methods to increase production of a hydrocarbon from an underground formation by injecting a mixture containing an ether and carbon dioxide. The composition of the mixture, a pressure for injecting the mixture, a duration of an injection time, a duration of a time delay between injection of the mixture and producing the hydrocarbon, a pressure for producing the hydrocarbon, a duration of a production time and/or a number of cycles of injection and production can be selected (e.g., optimized) using a model to enhance (e.g., maximize) recovery of the hydrocarbon and/or sequestration of carbon dioxide in the underground formation.

### BACKGROUND

Hydrocarbon recovery from tight or unconventional reservoirs (e.g. low permeability shales) may be low, leaving the majority of the hydrocarbons in the reservoir. Mixtures of gases may be injected to increase hydrocarbon recovery.

### SUMMARY

The disclosure relates to methods to increase production of a hydrocarbon (e.g. oil, gas) from an underground formation by injecting a mixture containing an ether and carbon dioxide. The methods can result in increased hydrocarbon yield and revenue from a hydrocarbon-producing (e.g. oil-producing and/or gas-producing) well.

Without wishing to be bound by theory, it is believed that the ether can reduce (e.g., prevent) water blockage of the hydrocarbon. Water (e.g., formation water, water from fracturing fluids) may trap hydrocarbons in pores of the underground formation and interfere with, or even prevent, recovery of the hydrocarbon. The ether may dissolve in water and diffuse through the water layer blocking the hydrocarbons to dissolve in and swell the hydrocarbons, thereby unblocking the hydrocarbon containing pores and recovering the trapped hydrocarbons. The methods may therefore enable access to hydrocarbons trapped by water that would be inaccessible to other enhanced recovery fluids.

Without wishing to be bound by theory, it is believed that the mixture of ether and carbon dioxide can dissolve in the hydrocarbon (e.g., oil, bitumen) to increase the volume and/or reduce the viscosity of the hydrocarbon, which may result in an increase in hydrocarbon production, relative to the absence of the injection mixture. Without wishing to be bound by theory, it is believed that the reduction in viscosity of the hydrocarbon may aid the flow of the hydrocarbon to the surface, thereby increasing production of the hydrocarbon. The ether may interact with heavier organic material (e.g., kerogen, bitumen) and cause it to swell, thereby increasing bitumen production. Without wishing to be bound by theory, the high vapor pressure of ether may increase hydrocarbon production relative to other solvents (e.g. alcohols such as methanol and ethanol) with a lower vapor pressure.

Without wishing to be bound by theory, it is believed that the carbon dioxide may interact with the kerogen (e.g., absorb and/or adsorb onto the kerogen) and cause the kerogen to release adsorbed hydrocarbon molecules which can then be produced, thereby increasing hydrocarbon production. The methods of the disclosure can therefore also enable the sequestration of carbon dioxide in the underground formations leading to lower carbon dioxide emissions per barrel of hydrocarbon (e.g., oil, natural gas) produced relative to other hydrocarbon production methods. For example, some of the carbon dioxide retained on the kerogen by adsorption and/or inside the kerogen by absorption enables sequestration of the carbon dioxide in the underground formation.

The composition of the mixture, the injection pressure used for the mixture, the time duration for injection, the time duration of the delay between injecting the mixture and producing the hydrocarbon, the pressure used for producing the hydrocarbon, the time duration for production the hydrocarbon, and/or the number of injection and/or production cycles can be selected (e.g., optimized) using a model to maximize recovery of the hydrocarbon and/or sequestration of carbon dioxide in the underground formation.

The injection mixtures can be formed of gases that are inexpensive relative to other injection gases (e.g. hydrocarbon gases such as methane, ethane and propane). The injection mixtures may be more soluble in water than other injection gases (e.g. hydrocarbon gases such as methane, ethane and propane), thereby decreasing water blockage and increasing hydrocarbon production relative to other injection gases. The ether(s) used may not need to be separated from the hydrocarbon because they can be used as any other hydrocarbon for industrial use, further reducing costs relative to the use of other injection mixtures that require separation.

In a first aspect, the disclosure provides a method, including injecting a mixture including an ether and carbon dioxide into an underground formation, and producing a hydrocarbon from the underground formation, wherein the mixture includes a mole fraction of carbon dioxide of at least 5%.

In some embodiments, the mixture includes a mole fraction of carbon dioxide of at least 10%.

In some embodiments, an amount of carbon dioxide in the mixture is greater than an amount of ether in the mixture.

In some embodiments, the mixture consists essentially of the ether and carbon dioxide.

In some embodiments, the ether includes dimethyl ether, diethyl ether and/or ethyl methyl ether.

In some embodiments, the method further includes a time delay between injecting the mixture and producing the hydrocarbon from the underground formation.

In some embodiments, the carbon dioxide is sequestered in the underground formation.

In some embodiments, the method further includes, before injecting the mixture, determining an amount of carbon dioxide and an amount of ether in the mixture, a pressure for injecting the mixture, a duration of an injection time, a duration for the time delay between injection of the mixture and producing the hydrocarbon, a pressure for producing the hydrocarbon a duration of a production time and/or a number of cycles of injection and production based on simulations using a model, wherein the simulations enhances the recovery of a hydrocarbon and/or sequestration of the carbon dioxide in the underground formation.

In some embodiments, the underground formation includes an unconventional reservoir.

In some embodiments, the unconventional reservoir includes a low-permeability shale.

In a second aspect, the disclosure provides a method, including using a model to perform hydrocarbon estimated ultimate recovery simulations to determine an injection mixture to optimize recovery of a hydrocarbon from an underground formation, wherein the injection mixture includes an ether and carbon dioxide, the injection mixture includes a mole fraction of carbon dioxide of at least 5%, and using the simulations includes varying an amount of the ether and an amount of carbon dioxide in the injection mixture, an injection pressure of the injection mixture, a production pressure of the hydrocarbon, a duration of a time delay between injection of the injection mixture and recovery of the hydrocarbon, a duration of an injection time of the injection mixture, a duration of a production time of the hydrocarbon, and/or a number of cycles of injection and production.

In certain embodiments, the hydrocarbon estimated ultimate recovery simulations optimize the amount of carbon dioxide and the amount of the ether in the injection mixture, the injection pressure, the duration of the injection time, the duration for the time delay between injection of the injection mixture and producing the hydrocarbon, the production pressure, the duration of the production time, and/or a number of cycles of injection and production to optimize recovery of a hydrocarbon and/or sequestration of the carbon dioxide in the underground formation.

In certain embodiments, the hydrocarbon estimated ultimate recovery simulations are huff-n-puff hydrocarbon estimated ultimate recovery simulations.

In certain embodiments, the model includes a well geometry and/or a reservoir property distribution.

In certain embodiments, the injection mixture includes a mole fraction of carbon dioxide of at least 10%.

In certain embodiments, an amount of carbon dioxide in the injection mixture is greater than an amount of ether in the injection mixture.

In certain embodiments, the injection mixture consists essentially of the ether and carbon dioxide.

In certain embodiments, the ether includes dimethyl ether, diethyl ether and/or ethyl methyl ether.

In certain embodiments, the underground formation includes an unconventional reservoir.

In certain embodiments, the unconventional reservoir includes a low-permeability shale.

### BRIEF DESCRIPTION OF THE FIGURES

FIG. 1 schematically depicts a system that includes a well, a subterranean rock formation and a gas mixture.

FIG. 2 is a flow diagram for a method.

FIG. 3 is a flow diagram for a method.

FIG. 4 depicts a visualization of an unconventional reservoir.

FIG. 5 is a table of data.

FIG. 6 depicts simulated data of volume changes relative to pressure for different injection gas mixtures.

FIG. 7 depicts simulated data of viscosity relative to pressure for different injection gas mixtures.

FIG. 8 depicts simulated data comparing cumulative oil production with injection and production pressures.

FIG. 9 depicts simulated data comparing cumulative oil production with the composition of the injection mixture.

FIG. 10 depicts simulated data comparing the amount of carbon dioxide sequestered with the composition of the injection mixture.

### DETAILED DESCRIPTION

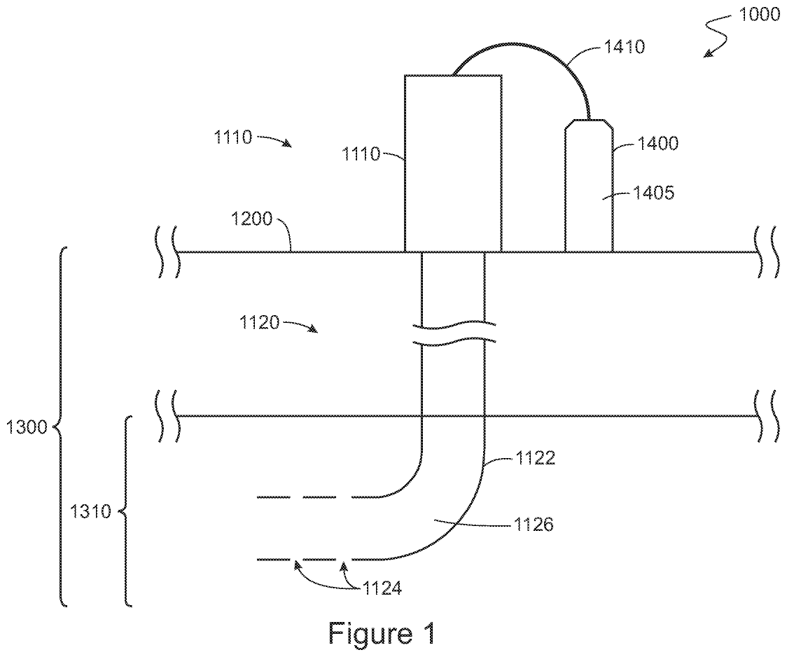

FIG. 1 schematically depicts a system 1000 that includes a hydrocarbon-producing (e.g., oil-producing and/or gas-producing) well 1100 having a first portion 1110 above a surface of the earth 1200 and a second portion 1120 that extends below the surface 1200 and into a subterranean rock formation 1300. The portion 1120 includes a casing 1122 having perforations 1124. The subterranean rock formation 1300 includes a hydrocarbon-producing (e.g., oil-producing and/or gas-producing) zone 1310. The well 1100 has a casing 1122 with perforations 1124 that allow for fluid communication between an interior region 1126 of the casing 1122 and the hydrocarbon-producing zone 1310. A source 1400 houses an injection gas mixture 1405 containing an ether and carbon dioxide. The source 1400 is connected to the well 1100 via a connection 1410 such that the gas mixture 1405 can be injected into the interior region 1126 of the casing 1122 and interact with the hydrocarbon-producing zone 1310 via the perforations 1124 in the casing 1122.

In some embodiments, the hydrocarbon-producing zone 1310 may be an unconventional reservoir, such as, for example, a low-permeability shale. In some embodiments, the hydrocarbon-producing zone 1310 contains one or more hydraulic fractures. In some embodiments, the injected gas mixture 1405 enters the hydrocarbon-producing zone 1310 through the fractures and interacts with the hydrocarbons in the hydrocarbon-producing zone 1310. In some embodiments, the well 1100 is a horizontal well.

In some embodiments, the mixture 1405 may be added to a fracturing fluid used to create hydraulic fractures. In some embodiments, the mixture 1405 may be added with the first chemicals injected during a fracturing process. Without wishing to be bound by theory, it is believed that injection of the mixture 1405 with the first chemicals injected during the fracturing process may enable favorable contact of the mixture 1405 and hydrocarbons in the hydrocarbon-producing zone 1310 prior to the addition of all aqueous components of the fracturing process and thereby reduce (e.g., prevent) water blocking due to the aqueous fracturing fluid. In some embodiments, the mixture 1405 may be added after most (e.g., all) components of the fracturing process have been injected. Without wishing to be bound by theory, it is believed that the ether in the mixture 1405 can overcome water blockage caused by the fracturing fluid by dissolving in water and diffusing through the water layer blocking the hydrocarbons to dissolve in and swell the hydrocarbons.

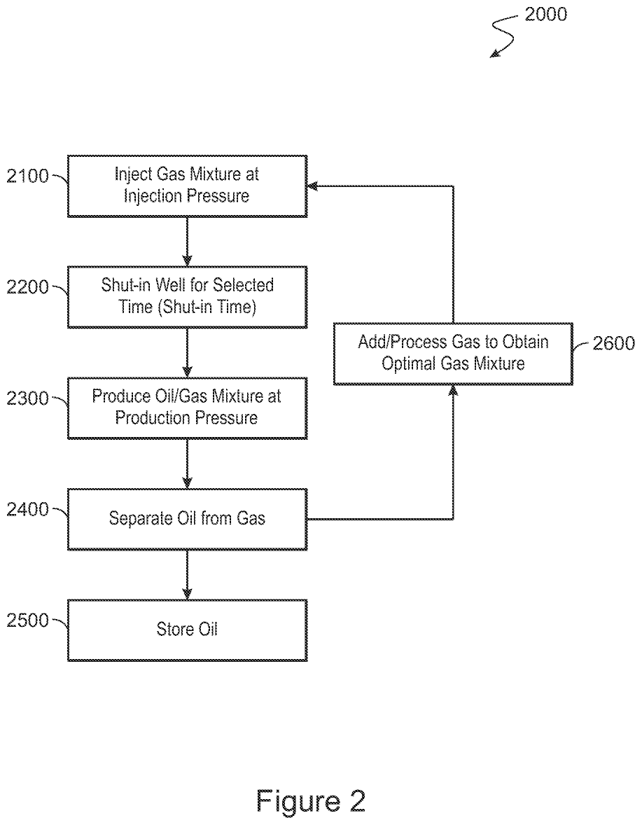

FIG. 2 depicts a flowchart 2000 for a method of enhancing recovery of a hydrocarbon from an underground formation (e.g., a reservoir) by injecting a mixture containing an ether and carbon dioxide. In step 2100, the gas mixture 1405 is injected in the well 1100 at an injection pressure and for an injection time. In step 2200, the well 1100 is shut in for a set amount of time, providing a time delay between the injection of the mixture 1405 and production of the hydrocarbon (i.e., a soaking time). Without wishing to be bound by theory, it is believed that the time delay enables the gas mixture 1405 to interact with the hydrocarbon (e.g., oil, bitumen) and reservoir matrix to extract the hydrocarbon (e.g., oil, gas). In step 2300, the hydrocarbon, as well as at least a portion of the mixture 1405, are produced at a production pressure and for a production time. Fluids containing hydrocarbon extracted from the hydrocarbon-producing zone 1310 are produced into the interior region 1126 of the casing 1122 and brought to the surface 1200 where they can be accessed from the well 1100. In step 2400, the hydrocarbon and at least a portion of the remaining gas mixture 1405 produced are separated. In certain embodiments, step 2400 includes separating the hydrocarbon from the remaining carbon dioxide. In step 2500, the hydrocarbon produced from the well 1100 is stored in an appropriate storage container, such as, for example, steel tanks located at the well site, or central tanks via a pipeline. In step 2600, the produced gas is reused to regenerate the gas mixture 1405. In certain embodiments, an additional gas may be added to the gas in step 2600 to regenerate the gas mixture 1405. In certain embodiments, the gas mixture of step 2600 may undergo additional processing to obtain the gas mixture 1405. The gas mixture 1405 generated in 2600 may then be reinjected into the well 1100 in step 2100. In certain embodiments, injection of the gas mixture 1405 in step 2100 may be performed after primary depletion production of the underground formation as the methods of the disclosure can enable the production of hydrocarbons that would not be produced during primary depletion production of the underground formation.

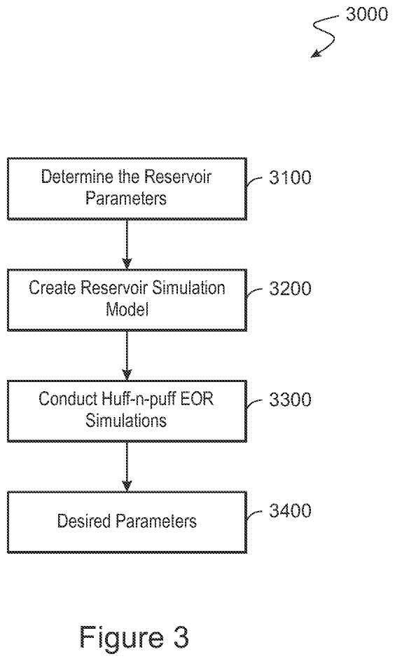

FIG. 3 depicts a flowchart 3000 for the implementation of a method using a model to perform hydrocarbon estimated ultimate recovery (EUR) simulations to determine a composition of the injection mixture, pressure and/or durations of time in steps 2100, 220 and/or 2300 of the flow chart 2000 in FIG. 2 to optimize recovery of a hydrocarbon from a reservoir. In step 3100, the composition of the reservoir oil, the reservoir pressure and the reservoir temperature are determined. In step 3200, a reservoir simulation model is created. In step 3300 appropriate hydrocarbon EUR simulations (e.g., Huff-n-puff hydrocarbon EUR simulations) are performed. In step 3400, one or more optimal parameters are obtained which may then be used in steps 2100, 220 and/or 2300 of the flow chart 2000 in FIG. 2.

In some embodiments, the reservoir pressure may be determined by pressure transient tests. In some embodiments, the reservoir temperature may be determined by temperature log measurements. In some embodiments, properties (e.g., composition, phase behavior) of the produced reservoir fluids (e.g., oil, gas) may be determined by a laboratory test.

In certain embodiments, the model may be created using the well geometry, reservoir property distribution (e.g., porosity, permeability, oil/water saturation, reservoir pressure) and/or available well details (e.g., well trajectory, perforation locations, details of any hydraulic fractures created to accelerate production). In certain embodiments, the reservoir shape and/or reservoir property distribution may be determined by integrating data from seismic surveys and well logs. In certain embodiments, well geometry and/or hydraulic fracture characteristics may be used in the model based on surveys conducted during well drilling and/or completion.

In some embodiments, the simulations vary and/or enhance (e.g., optimize) the amount of carbon dioxide in the mixture, the amount of the ether in the injection mixture, the injection pressure, the duration of the injection time, the duration for the time delay between injection of the injection mixture and production of the hydrocarbon, the production pressure, the duration of the production time, and/or the number of cycles of injection and production to enhance (e.g., optimize) recovery of the hydrocarbon and/or sequestration of the carbon dioxide in the reservoir.

In some embodiments, the composition and/or the phase behavior of the reservoir fluid may be used to specify the composition of the reservoir fluid in the simulation model and/or the parameters of the equation of state (e.g., temperature and pressure dependence of a density of the reservoir fluid, temperature and pressure dependence of a viscosity of the reservoir fluid, quantity of gas dissolved in the hydrocarbon (e.g. oil), bubble point pressure of the hydrocarbon (e.g. oil)). In some embodiments, swelling tests with the injection gas may be performed to determine the minimum injection pressure needed, the reduction in oil viscosity and/or oil density/swelling upon mixing with injection gas and/or the tuning of the equation of state for use in the simulations. In some embodiments, previously measured parameters such as the minimum injection pressure needed, reduction in oil viscosity and/or oil density/swelling upon mixing with injection gas and/or the tuning of the equation of state available in the literature may be used in the simulations.

In some embodiments, the mixture contains an ether and carbon dioxide. In some embodiments, the mole fraction of ether in the mixture is at least 5 (e.g. at least 10, at least 15, at least 20, at least 25, at least 30, at least 35, at least 40, at least 45, at least 50, at least 55, at least 60, at least 65, at least 70, at least 75, at least 80, at least 85, at least 90, at least 95) % and at most 100 (e.g. at most 95, at most 90, at most 85, at most 80, at most 75, at most 70, at most 65, at most 60, at most 55, at most 50, at most 45, at most 40, at most 35, at most 30, at most 25, at most 20, at most 15, at most 10) %. In some embodiments, the mole fraction of carbon dioxide in the mixture is at least 5 (e.g. at least 10, at least 15, at least 20, at least 25, at least 30, at least 35, at least 40, at least 45, at least 50, at least 55, at least 60, at least 65, at least 70, at least 75, at least 80, at least 85, at least 90, at least 95) % and at most 100 (e.g. at most 95, at most 90, at most 85, at most 80, at most 75, at most 70, at most 65, at most 60, at most 55, at most 50, at most 45, at most 40, at most 35, at most 30, at most 25, at most 20, at most 15, at most 10) %. In some embodiments, the mole fraction of carbon dioxide in the mixture is greater than the mole fraction of ether in the mixture. In some embodiments, the mixture consists essentially of the ether and carbon dioxide. In some embodiments, the ether may be dimethyl ether, diethyl ether and ethyl methyl ether. Optionally, the mixture may contain a combination of different ethers, in which case the mole fraction of ether noted above refers to the total mole fraction of the ethers in the mixture. In some embodiments, the mixture consists of only carbon dioxide without ether. In some embodiments, the mixture consist of only ether without carbon dioxide.

In certain embodiments, the composition of the injection mixture is simulated as pure carbon dioxide or pure ether (e.g., dimethyl ether, diethyl ether) followed by different combinations of carbon dioxide and ether. In certain embodiments, more than one type of ether (e.g., dimethyl ether, diethyl ether, ethyl methyl ether) is simultaneously employed in the simulations.

In some embodiments, the mixture contains an additive. In some embodiments, the additive is selected from the group consisting of a hydrocarbon (e.g. methane, ethane, propane) and an inert gas (e.g. nitrogen, helium, neon, argon, xenon). In some embodiments, the additive is a chemical available at the location and deemed beneficial to the process based on the simulations. In some embodiments, the additive and/or an amount of the additive may be determined by the simulations.

In certain embodiments, the bottomhole injection pressure is at least 17,000 kilopascals (kpa) (2465 psi) and at most 600,000 kpa (8700 psi). In certain embodiments, the bottomhole production pressure is at least 3,500 kpa (507 psi) and at most 14,000 kpa (2030 psi).

In some embodiments, the injection time is at least 1 months and at most 6 months. In some embodiments, the production time is at least 1 months and at most 24 months.

In some embodiments, the duration of the delay between injection of the gas mixture and production of the hydrocarbon is at least 1 (e.g. at least 2, at least 3, at least 4, at least 5, at least 6) week and at most 6 months. Without wishing to be bound by theory, it is believed that during the delay between the injection of the mixture and producing the hydrocarbon while the well is shut in, the gas of the mixture can interact with the oil in the reservoir causing oil swelling and vaporization of at least a portion of the hydrocarbon phase and at least a portion of the carbon dioxide may attach to the reservoir rock by absorption and/or adsorption.

In certain embodiments, the number of cycles of injection of the gas mixture and production is at least 1 and at most 20 (e.g. at most 8, at most 6), depending on the value of the recovery in each cycle.

In some embodiments, the simulations may be used to determine an amount of carbon dioxide sequestered. In some embodiments, the mole percentage of carbon dioxide retained on the kerogen as adsorbed phase and inside the kerogen as absorbed phase is at least 50 and at most 80%. Without wishing to be bound by theory, it is believed that the carbon dioxide retained on the kerogen as adsorbed phase and inside the kerogen as absorbed phase is permanently sequestered.

### EXAMPLE

Samples of produced oil and gas from two different wells were sent to a service company laboratory to measure composition, conduct PVT analysis and swelling tests with candidate gases (CO₂, ethane, dimethyl ether (DME)). The measurements showed significant swelling and viscosity reduction with each injected gas as the injection pressure increased.

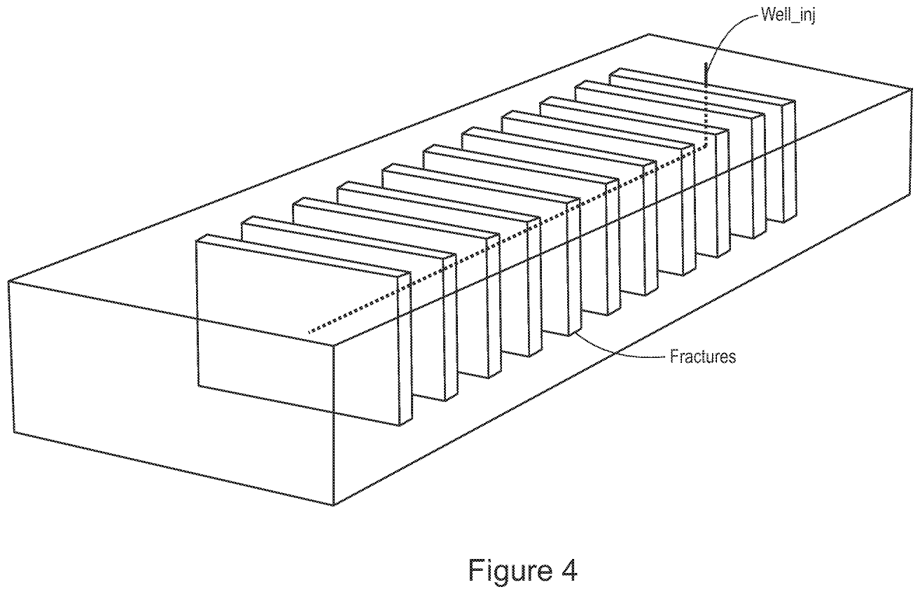

Petrel was used to integrate reservoir geometry and properties and CMG platform CMOST was used to conduct compositional reservoir simulations using CMG-GEM, where the composition of the injected gas mixture was varied from pure CO₂ to pure DME by increasing the fraction of DME. The Injection bottomhole pressure (BHP) was varied from 35,700 Kpa to 59,500 Kpa and the production BHP was varied from 8,250 to 13,700 Kpa. FIG. 4 shows a three-dimensional visualization of an unconventional reservoir with a horizontal well and 12 planar fractures made using CMG-Results software.

A process was simulated with the following steps:
1. Primary depletion production was conducted for 6 years and 10 months (M02/D01/Y00 to M12/D01/Y06) with bottom-hole pressure set at 11,000 Kpa.
2. Selected gas mixture containing carbon dioxide and dimethyl ether was injected into the well at a selected bottom-hole pressure (Pi) (35,700 Kpa to 59,500 Kpa) for 3 months (M12/D01/Y06 to M03/D01/Y07). The range of injection BHP was guided by the results of the swelling tests.
3. Production from the well was performed by setting the bottom-hole pressure to the bottom-hole production pressure (Pp) for 3 months (M03/D01/Y07 to M06/D01/Y07). The value of production BHP was varied from 8,250 to 13,700 Kpa, guided by the observed values in typical field operations.
4. Selected gas mixture was injected into the well at a selected bottom-hole pressure (Pi) for 3 months (M06/D01/Y07 to M09/D01/Y07).
5. Production from the well was performed by setting the bottom-hole pressure to bottom-hole production pressure (Pp) for 3 months (M09/D01/Y07 to M12/D01/Y07).

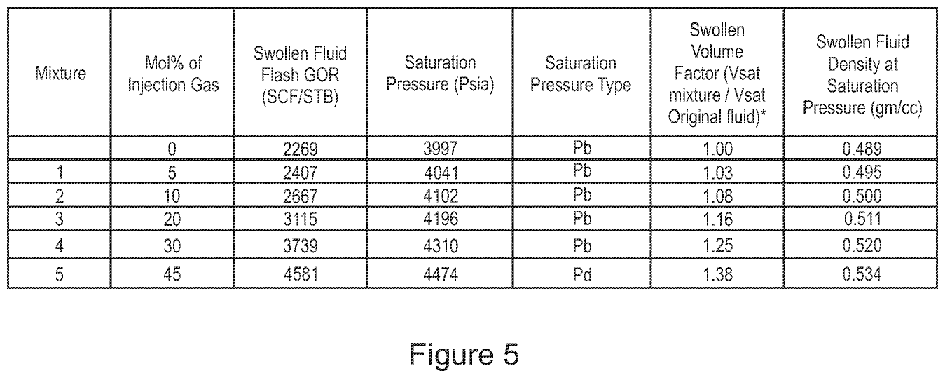

Sample results with one reservoir fluid and CO₂ as an example of the type of data and results obtained are shown in FIGS. 5-7.

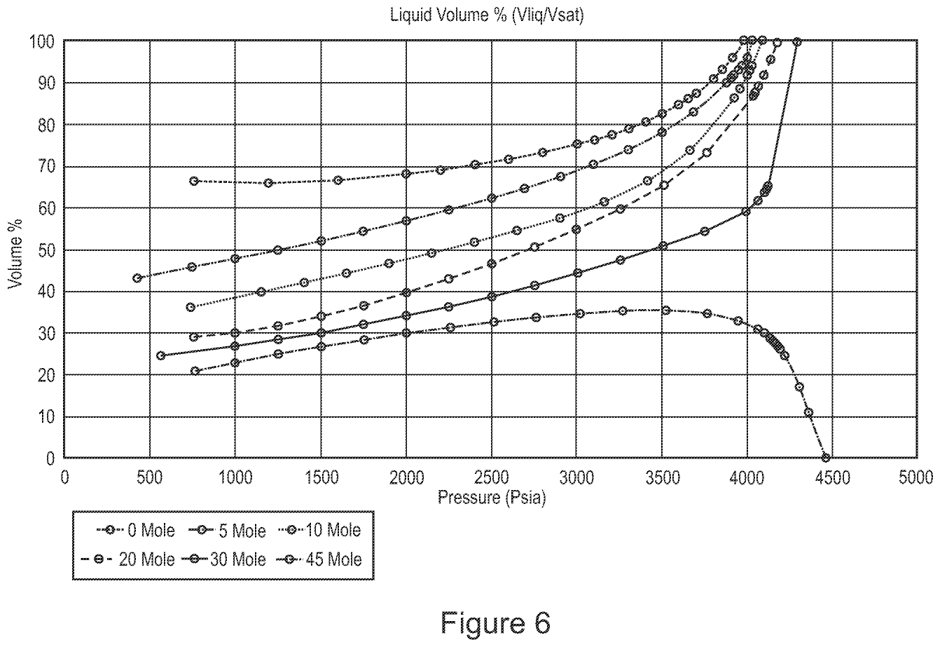

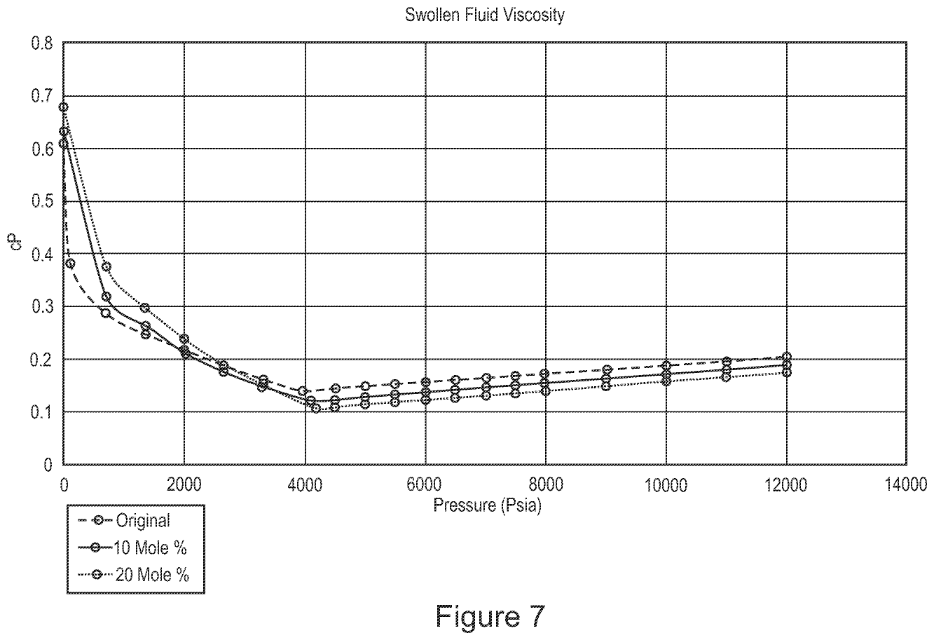

FIG. 5 shows that that the minimum bottomhole injection pressure needed is less than 4581 psia but greater than 3739 psia. FIG. 6 shows that increasing injection gas pressure causes more swelling until the fluid system changes from an oil (30 mole % injection gas) to a condensate system (45 mole % injection gas). FIG. 7 shows that the viscosity of oil at high pressures decreases with increasing amount of injection gas

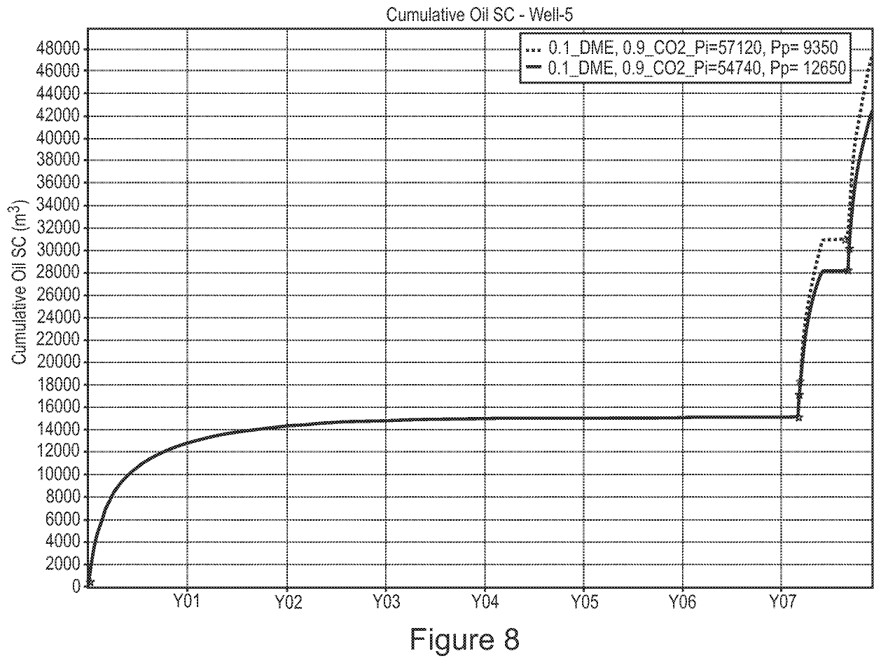

FIG. 8 shows simulation results for the cumulative oil production as the injection pressure and production pressure were varied for the same injection gas mixture and reservoir fluid. FIG. 8 shows that the injection pressure and production pressure can affect the cumulative oil production for the same injection gas mixture and reservoir fluid.

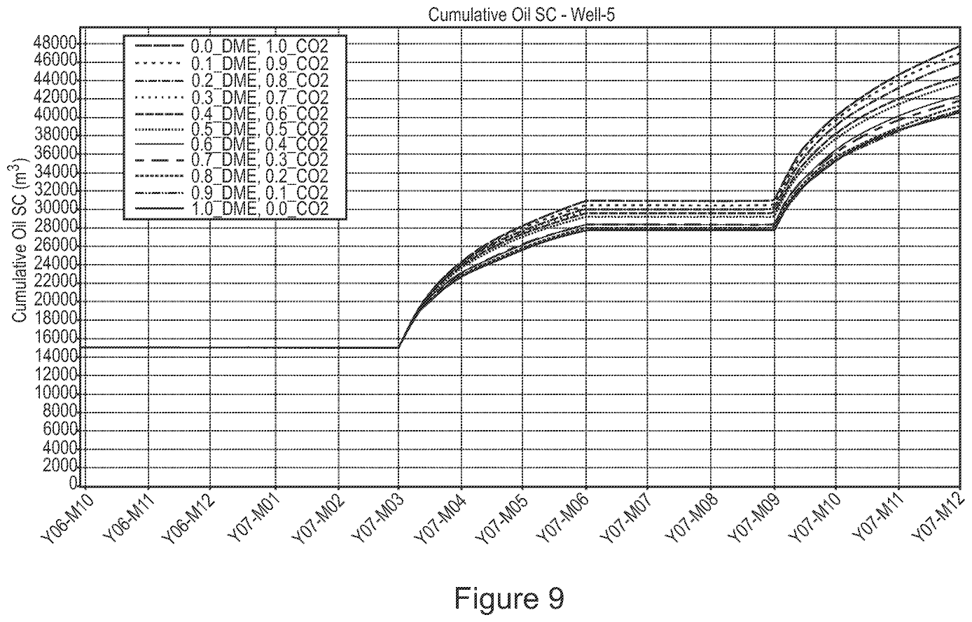

FIG. 9 shows simulation results for the cumulative oil production as the composition of the injection gas was varied for the same injection pressure, production pressure and reservoir conditions. The mole fractions of carbon dioxide and dimethyl ether were varied from 0.0 to 1.0.

FIG. 9 shows that the composition of the injection gas mixture affects the cumulative oil production. For the specific injection pressure, production pressure and reservoir conditions simulated, the mixture containing pure carbon dioxide provided the highest cumulative oil production.

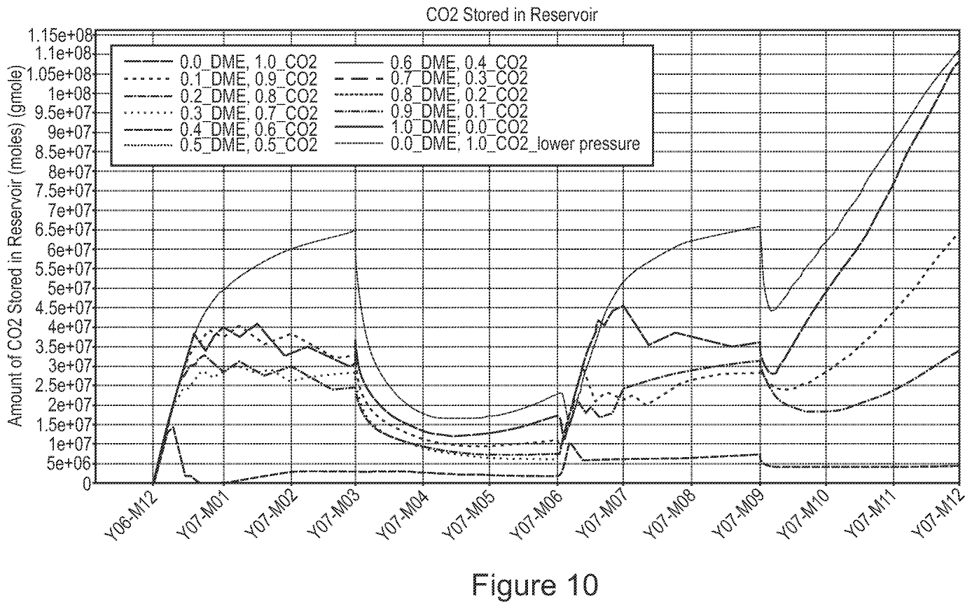

FIG. 10 shows how the amount of carbon dioxide sequestered in the reservoir changes with the composition of the injection gas, the injection pressure and the production pressure. FIG. 10 shows that the largest amount of carbon dioxide was sequestered when pure carbon dioxide was injected. Additionally, FIG. 10 shows that the injection pressure affects the amount of carbon dioxide sequestered.

The results of several example simulations are shown in Table 1. Table 1 shows that the amount of oil produced varies as the injection gas composition, injection gas pressure and production pressure are varied. For a target reservoir, simulations should be performed to identify the optimal mixture composition, injection pressure and production pressure. Additional optimization can be conducted by varying the duration of the injection time, the duration of the production time and the number of cycles of injection and production.

TABLE 1
Simulation results

| | Injection | Production | | | Cumulative |
|---|---|---|---|---|---|
| | BHP | BHP | Fraction | Fraction | Oil |
| ID | (Kpa) | (Kpa) | CO2 | DME | (m³) |
| 0 | 47,600 | 11,000 | 0.50 | 0.50 | 41,380 |
| 1 | 35,700 | 12,100 | 0.00 | 1.00 | 28,418 |
| 2 | 38,080 | 8,800 | 0.70 | 0.30 | 36,511 |
| 3 | 57,120 | 9,350 | 0.90 | 0.10 | 47,419 |
| 4 | 59,500 | 11,000 | 0.40 | 0.60 | 42,412 |
| 5 | 52,360 | 13,200 | 0.10 | 0.90 | 35,898 |
| 6 | 54,740 | 12,650 | 0.90 | 0.10 | 42,496 |
| 7 | 45,220 | 8,250 | 0.10 | 0.90 | 37,771 |
| 8 | 42,840 | 13,750 | 0.50 | 0.50 | 32,130 |
| 9 | 59,500 | 11,000 | 0.00 | 1.00 | 40,613 |
| 10 | 40,460 | 11,550 | 0.30 | 0.70 | 31,862 |
| 11 | 42,840 | 10,450 | 0.80 | 0.20 | 37,464 |
| 12 | 47,600 | 11,550 | 0.60 | 0.40 | 37,838 |
| 13 | 49,980 | 9,900 | 0.20 | 0.80 | 38,111 |
| 14 | 35,700 | 13,200 | 1.00 | 0.00 | 30,072 |
| 15 | 42,840 | 13,750 | 0.00 | 1.00 | 30,577 |
| 16 | 47,600 | 12,650 | 0.60 | 0.40 | 36,590 |
| 17 | 35,700 | 8,250 | 0.90 | 0.10 | 37,064 |
| 18 | 45,220 | 8,250 | 1.00 | 0.00 | 43,421 |
| 19 | 52,360 | 13,200 | 1.00 | 0.00 | 41,245 |
| 20 | 52,360 | 10,450 | 1.00 | 0.00 | 44,750 |
| 21 | 49,980 | 9,350 | 0.20 | 0.80 | 38,879 |
| 22 | 59,500 | 11,550 | 0.90 | 0.10 | 46,185 |
| 23 | 52,360 | 9,350 | 1.00 | 0.00 | 46,125 |

What is claimed:

1. A method, comprising:
injecting a mixture comprising an ether and carbon dioxide into an underground formation; and
producing a hydrocarbon from the underground formation,
wherein the mixture comprises a mole fraction of carbon dioxide of at least 5%.

2. The method of claim 1, wherein the mixture comprises a mole fraction of carbon dioxide of at least 10%.

3. The method of claim 1, wherein an amount of carbon dioxide in the mixture is greater than an amount of ether in the mixture.

4. The method of claim 1, wherein the mixture consists essentially of the ether and carbon dioxide.

5. The method of claim 1, wherein the ether comprises at least one member selected from the group consisting of dimethyl ether, diethyl ether and ethyl methyl ether.

6. The method of claim 1, further comprising a time delay between injecting the mixture and producing the hydrocarbon from the underground formation.

7. The method of claim 6, wherein the carbon dioxide is sequestered in the underground formation.

8. The method of claim 7, further comprising, before injecting the mixture, determining at least one parameter selected from the group consisting of an amount of carbon dioxide and an amount of ether in the mixture, a pressure for injecting the mixture, a duration of an injection time, a duration for the time delay between injection of the mixture and producing the hydrocarbon, a pressure for producing the hydrocarbon a duration of a production time and a number of cycles of injection and production based on simulations using a model;
wherein the simulations enhances at least one parameter selected from the group consisting of recovery of a hydrocarbon and sequestration of the carbon dioxide in the underground formation.

9. The method of claim 1, wherein the underground formation comprises an unconventional reservoir.

10. The method of claim 9, wherein the unconventional reservoir comprises a low-permeability shale.

11. A method, comprising:
using a model to perform hydrocarbon estimated ultimate recovery simulations to determine an injection mixture to optimize recovery of a hydrocarbon from an underground formation,
wherein:
the injection mixture comprises an ether and carbon dioxide;
the injection mixture comprises a mole fraction of carbon dioxide of at least 5%; and
using the simulations comprise varying at least one parameter selected from the group consisting of an amount of the ether and an amount of carbon dioxide in the injection mixture, an injection pressure of the injection mixture, a production pressure of the hydrocarbon, a duration of a time delay between injection of the injection mixture and recovery of the hydrocarbon, a duration of an injection time of the injection mixture, a duration of a production time of the hydrocarbon, and a number of cycles of injection and production.

12. The method of claim 11, wherein the hydrocarbon estimated ultimate recovery simulations optimize at least one parameter selected from the group consisting of the amount of carbon dioxide and the amount of the ether in the injection mixture, the injection pressure, the duration of the injection time, the duration for the time delay between injection of the injection mixture and producing the hydrocarbon, the production pressure, the duration of the production time, and a number of cycles of injection and production to optimize at least one parameter selected from the group consisting of recovery of a hydrocarbon and sequestration of the carbon dioxide in the underground formation.

13. The method of claim 11, wherein the hydrocarbon estimated ultimate recovery simulations are huff-n-puff hydrocarbon estimated ultimate recovery simulations.

14. The method of claim 11, wherein the model comprises at least one parameter selected from the group consisting of a well geometry and a reservoir property distribution.

15. The method of claim 11, wherein the injection mixture comprises a mole fraction of carbon dioxide of at least 10%.

16. The method of claim 11, wherein an amount of carbon dioxide in the injection mixture is greater than an amount of ether in the injection mixture.

17. The method of claim 11, wherein the injection mixture consists essentially of the ether and carbon dioxide.

18. The method of claim 11, wherein the ether comprises at least one member selected from the group consisting of dimethyl ether, diethyl ether and ethyl methyl ether.

19. The method of claim 11, wherein the underground formation comprises an unconventional reservoir.

20. The method of claim 19, wherein the unconventional reservoir comprises a low-permeability shale.
